(19) United States
(12) Patent Application Publication
(10) Pub. No.: US 2015/0279318 A1
(43) Pub. Date: Oct. 1, 2015

(54) DISPLAY APPARATUS, DISPLAY SYSTEM, AND CONTROL METHOD THEREOF

(71) Applicant: SAMSUNG ELECTRONICS CO., LTD., Suwon-si (KR)

(72) Inventors: Ho-seop LEE, Seongnam-si (KR); Seong-phil CHO, Seoul (KR); Do-young KWAG, Seoul (KR); Dae-sik KIM, Hwaseong-si (KR)

(73) Assignee: SAMSUNG ELECTRONICS CO., LTD., Suwon-si (KR)

(21) Appl. No.: 14/671,520

(22) Filed: Mar. 27, 2015

(30) Foreign Application Priority Data
Mar. 28, 2014 (KR) 10-2014-0037151

(51) Int. Cl. G09G 5/02; G09G 3/32; G06T 1/60; G09G 5/18

(52) U.S. Cl. CPC G09G 5/02; G09G 5/18; G09G 3/32; G06T 1/60

(57) ABSTRACT

A display apparatus is provided. A display apparatus includes a display panel including a plurality of subpixels, the plurality of subpixels including red (R) subpixels, green (G) subpixels, and blue (B) subpixels, a panel driver configured to drive the display panel, and a controller configured to control the panel driver to, in one image frame section, sequentially turn on a first group of subpixels of the plurality of subpixels based on a predetermined group unit, and turn on a second group of subpixels of the plurality of subpixels which is in a location shifted by a predetermined subpixel unit with respect to the first group of subpixels. Accordingly, even though a LED display panel displays an image, decrease in resolution may be prevented. In addition, a bezel-less display apparatus may be realized using the LED display panel.

### CROSS-REFERENCE TO RELATED APPLICATION(S)

This application claims priority from Korean Patent Application No. 10-2014-0037151, filed on Mar. 28, 2014, in the Korean Intellectual Property Office, the disclosure of which is incorporated herein by reference in its entirety.

### BACKGROUND

1. Field

Apparatuses and methods consistent with exemplary embodiments relate to a display apparatus, a display system, and a control method thereof, and more particularly, to a display apparatus which controls a plurality of subpixels, a display system, and a control method thereof.

2. Description of Related Art

Due to technological developments of electronics, many kinds of display apparatuses such as televisions, (TVs), mobile phones, personal computers (PCs), notebook PCs, personal digital assistants (PDAs) are now generally used in most households.

As the use of display apparatuses increases, users' needs for more diverse functions also increases. In order to meet users' increasing needs, manufacturers have developed products with new functions.

For example, certain display apparatuses of the related art display an image using a liquid crystal display (LCD) panel and a backlight. In contrast, other display apparatuses of the related art which use light emitting diodes (LEDs) (i.e., an LED display) do not need a backlight and therefore the thickness of these display apparatuses may be reduced.

However, in the related art, images which are is displayed using an LED display suffer from low resolution. In addition, the ability to increase the resolution of an LED display is limited due to locations of the components and electric wiring of the display.

Therefore, there is an increasing need for compensating for the resolution of an LED display through control of the LED display.

### SUMMARY

Exemplary embodiments may overcome the above disadvantages and other disadvantages not described above. However, exemplary embodiments are not required to overcome the disadvantages described above, and an exemplary embodiment may not overcome any of the problems described above.

One or more exemplary embodiments provide a display apparatus which controls a plurality of subpixels to compensate for the resolution of the display apparatus, a display system, and a control method thereof.

According to an aspect of an exemplary embodiment, there is provided a display apparatus including: a display panel including a plurality of subpixels, the plurality of subpixels including red (R) subpixels, green (G) subpixels, and blue (B) subpixels; a panel driver configured to drive the display panel; and a controller configured to control the panel driver to, in one image frame section, sequentially turn on a first group of subpixels of the plurality of subpixels based on a predetermined group unit, and turn on a second group of subpixels of the plurality of subpixels, which is in a location shifted by a predetermined subpixel unit with respect to a location of the first group of subpixels.

The controller may be further configured to sequentially turn on the first group of subpixels in a first subfield section of the image frame section, and turn on the second group of subpixels in a second subfield section of the image frame section, and wherein the second group of subpixels may include at least one subpixel included in the first group of subpixels.

The location of the second group of subpixels may be a location shifted by the predetermined subpixel unit in at least one of a vertical direction and a horizontal direction with respect to the location of the first group of subpixels.

The predetermined group unit may be determined according to a luminous pattern of the plurality of subpixels.

The controller may be further configured to shift the second group of subpixels by applying the predetermined subpixel unit differently according to a driving frequency of the display panel.

The location of the second group of subpixels may be a location rotated at a predetermined angle with respect to the location the first group of subpixels.

The plurality of subpixels may further include at least one of white (W) subpixels and yellow (Y) subpixels.

Each of the plurality of subpixels may be implemented with a light emitting diode (LED).

According to an aspect of another exemplary embodiment, there is provided a display apparatus including: a main display; a bezel to which a sub-display including a plurality of subpixels, the plurality of subpixels including red (R) subpixels, green (G) subpixels, and blue (B) subpixels, is attached; and a controller configured to scale an input image signal to correspond to a display area of the main display and a display area of the sub-display, divide the scaled image signal into portions corresponding to the respective display areas, and output the divided image signal, wherein the controller is further configured to, in one image frame section displayed on the display area of the sub-display, sequentially turn on a first group of subpixels of the plurality of subpixels based on a predetermined group unit, and turn on a second group of subpixels of the plurality of subpixels, which is in a location shifted by a predetermined subpixel unit with respect to a location of the first group of subpixels.

The controller may include: an image compensator configured to up-scale the input image signal according to a resolution determined based on a resolution of the display area of the main display and a resolution of the display area of the sub-display; an image divider configured to divide the up-scaled image signal into portions corresponding to the respective display areas; a sync signal generator configured to generate a sync signal to drive the sub-display; a storage configured to store the portion of the divided image signal corresponding to the display area of the sub-display; and a data selector configured to transmit the portion of the divided image signal stored in the storage to the sub-display based on the sync signal.

The controller may be further configured to sequentially turn on the first group of subpixels in a first subfield section of the image frame section, and turn on the second group of subpixels in a second subfield section of the image frame section, and wherein the second group of subpixels may include at least one subpixel included the first group of subpixels.

Each of the plurality of subpixels may be implemented with a light emitting diode (LED).

According to an aspect of another exemplary embodiment, there is provided a display system including: a plurality of display apparatuses each including a main display, and a bezel to which a sub-display including a plurality of subpixels, the plurality of subpixels including red (R) subpixels, green (G) subpixels, and blue (B) subpixels, is attached, wherein each display apparatus is configured to scale an input image signal to correspond to a display area of the main displays and a display area of the sub-displays, divide the scaled image signal into portions corresponding to the respective display areas of each display apparatus, output the divided image signal, and in one image frame section displayed on the respective display area of the sub-displays of each display apparatus, sequentially turn on a first group of subpixels of the plurality of subpixels based on a predetermined group unit, and turn on a second group of subpixels of the plurality of subpixels, which is in a location shifted by a predetermined subpixel unit with respect to a location of the first group of subpixels.

According to an aspect of another exemplary embodiment, there is provided a method for controlling a display apparatus including a display panel composed of a plurality of subpixels, the plurality of subpixels including red (R) subpixels, green (G) subpixels, and blue (B) subpixels, the method including: in one image frame section, sequentially turning on a first group of subpixels of the plurality of subpixels based on a predetermined group unit, and turning on a second group of subpixels of the plurality of subpixels, which is in a location shifted by a predetermined subpixel unit with respect to a location of the first group of subpixels.

The first group of subpixels may be turned on in a first subfield section of the image frame section, and the second group of subpixels may be turned on in a second subfield section of the image frame section, and wherein the second group of subpixels may include at least one subpixel included the first group of subpixels.

The location of the second group of subpixels may be a location shifted by the predetermined subpixel unit in at least one of a vertical direction and a horizontal direction with respect to the location of the first group of subpixels.

The predetermined group unit may be determined according to a luminous pattern of the plurality of subpixels.

The location of the second group of subpixels may be a location rotated at a predetermined angle with respect to the location of the first group of subpixels.

The plurality of subpixels may further include at least one of white (W) subpixels and yellow (Y) subpixels.

Each of the plurality of subpixels may be implemented with a light emitting diode (LED).

According to an aspect of another exemplary embodiment, there is provide a method of controlling a display apparatus including a main display, and a bezel to which a sub-display, including a plurality of subpixels, the plurality of subpixels including red (R) subpixels, green (G) subpixels, and blue (B) subpixels, is attached, the method including: scaling an input image signal to correspond to a display area of the main display and a display area of the sub-display; dividing the scaled image signal into portions corresponding to the respective display areas; and outputting the divided image signal, wherein the outputting the divided image signal includes, in one image frame section displayed on the display area of the sub-display, sequentially turning on a first group of subpixels of the plurality of subpixels based on a predetermined group unit, and turning on a second group of subpixels of the plurality of subpixels, which is in a location shifted by a predetermined subpixel unit with respect to a location of the first group of subpixels.

Each of the plurality of subpixels may be implemented with a light emitting diode (LED).

According to an aspect of another exemplary embodiment, there is provided a display apparatus including: a plurality of subpixels; a driver configured to drive the plurality of subpixels; and a controller configured to control the driver to activate a first plurality of subpixels forming a first pixel, in an activation, and shift the activation to a second plurality of subpixels forming a second pixel, wherein the first pixel and the second pixel share at least one common subpixel.

A location of the second pixel may be a location shifted with respect to a location of the first pixel.

The first pixel and the second pixel may be sequentially activated during a period corresponding to a single image frame.

According to an aspect of another exemplary embodiment, there is provided a display apparatus including: a plurality of subpixels; a driver configured to drive the plurality of subpixels; and a controller configured to control the driver to activate a first plurality of subpixels, in an activation, and shift the activation to a second plurality of subpixels, wherein the first plurality of subpixels and the second plurality of subpixel share at least one common subpixel.

According to an aspect of another exemplary embodiment, there is provided a method of controlling a display apparatus including a plurality of subpixels, the method including: first activating a first plurality of subpixels; and second activating a second plurality of subpixels, after the first activating, wherein the first plurality of subpixels and the second plurality of subpixels share at least one common subpixel.

The first activating and the second activating may occur in a same image frame.

Accordingly, even though a LED display panel displays an image, decrease in resolution may be prevented. In addition, a bezel-less display apparatus may be realized using the LED display panel.

Additional and/or other aspects and advantages of the exemplary embodiments will be set forth in part in the description which follows and, in part, will be obvious from the description, or may be learned by practice of the exemplary embodiments.

### BRIEF DESCRIPTION OF THE DRAWINGS

The above and/or other exemplary aspects will be more apparent by describing certain exemplary embodiments with reference to the accompanying drawings, in which:

FIG. 1 is a block diagram of a configuration of a display apparatus according to an exemplary embodiment;

FIG. 2 illustrates arrangement of a plurality of red (R), green (G), and blue (B) subpixels according to an exemplary embodiment;

FIG. 3 illustrates a process of controlling a plurality of subpixels according to an exemplary embodiment;

FIGS. 4 to 12 illustrate a process of controlling a plurality of subpixels according to other exemplary embodiments;

FIG. 13 is a block diagram of a configuration of a display apparatus according to another exemplary embodiment;

FIG. 14 is a block diagram of a detailed configuration of a controller according to an exemplary embodiment;

FIG. 15 illustrates a display system including a plurality of display apparatuses according to an exemplary embodiment;

FIG. 16 is a flow chart of a control method of a display apparatus including a display panel composed of a plurality of subpixels including R, G, and B subpixels according to an exemplary embodiment; and

FIG. 17 is a flow chart of a control method of a display apparatus including a main display and a bezel to which a sub display composed of a plurality of subpixels including R, G, and B subpixels is attached according to another exemplary embodiment.

### DETAILED DESCRIPTION OF EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

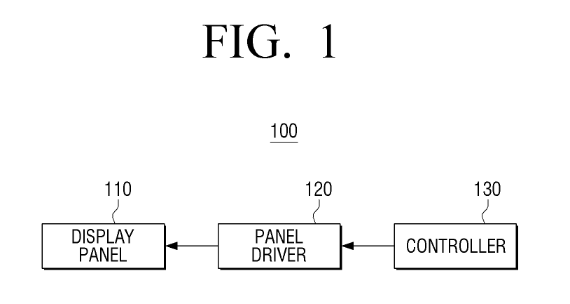

FIG. 1 is a block diagram of a configuration of a display apparatus according to an exemplary embodiment.

With reference to FIG. 1, the display apparatus 100 may include a display panel 110, a panel driver 120, and a controller 130. The display apparatus 100 may be implemented with diverse kinds of electronic apparatuses such as TVs, electronic bulletin boards, electronic tables, large format displays (LFDs), smart phones, tablets, desktop personal computers (PCs), and notebooks.

The display panel 110 includes a plurality of subpixels including red (R), green (G), and blue (B) subpixels. Three subpixels, including one R subpixel, one G subpixel, and one B subpixel, may compose a single pixel, and are arranged consecutively.

The panel driver 120 drives the display panel 110. For example, the panel driver 120 may turn on (i.e., activate) or off each subpixel by transmitting a clock signal having a predetermined driving frequency to each of the subpixels including R, G, and B subpixels.

Within a single image frame section, the controller 130 may control the panel driver 120 to sequentially turn on a plurality of subpixels based on a predetermined group unit and turn on groups of subpixels which are in locations shifted by a predetermined subpixel unit (i.e., with respect to the plurality of subpixels based on the predetermined group unit).

For example, the controller 130 may first turn on a plurality of subpixels based on a predetermined group unit in a first section of a single image frame among the plurality of image frames which composes an input image signal, and then sequentially (i.e., after turning on the plurality of subpixels) turn on groups of subpixels which are in locations shifted by a predetermined subpixel unit in the remaining sections of the single image frame.

That is, the controller 130 may sequentially turn on the plurality of subpixels included in the display panel 110 based on the predetermined group unit and a predetermined luminous location of a plurality of subpixels by time sharing of a single image frame section.

Accordingly, in the single image frame section, the controller 130 may turn on each of the plurality of subpixels in the display panel 110 at least once so that the resolution corresponding to the single image frame section may be compensated. Thus, the resolution of the display panel 110 may be increased.

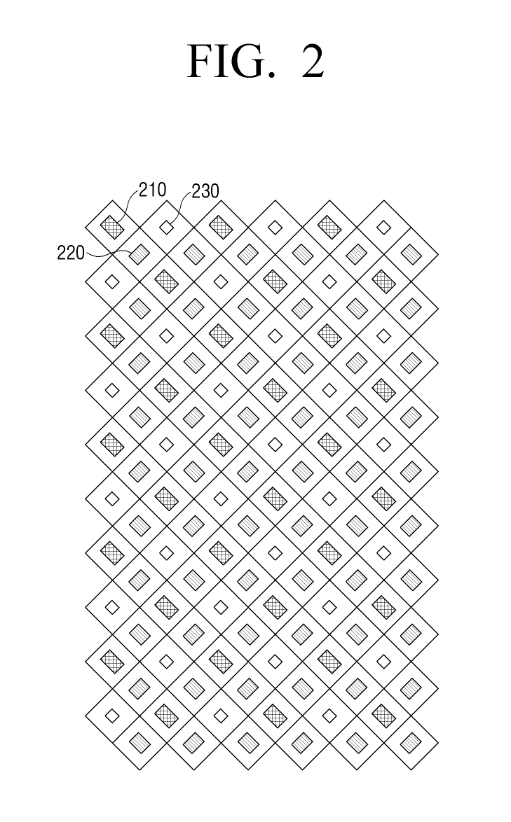

FIG. 2 illustrates arrangement of a plurality of red (R), green (G), and blue (B) subpixels according to an exemplary embodiment.

With reference to FIG. 2, the plurality of R, G, and B subpixels 230, 220, and 210 are consecutively arranged. The arrangement structure of the subpixels shown in FIG. 2 is not a PenTile structure (i.e., a structure in which subpixels are arranged side by side in a square form), but instead, is a structure in which the subpixels are diagonally arranged side by side.

The R, G, and B subpixels 230, 220, and 210 compose one pixel by being bound in a V shape. Similarly, other R, G, and B subpixels may compose single pixels by being bound in a V shape. When the R, G, and B subpixels are driven together, white light glows on the basis of a single pixel.

The arrangement structure of the R, G, and B subpixels is not limited to the structure in which the subpixels are diagonally arranged side by side as shown in FIG. 2, but may include diverse forms of arrangement structures. That is, the arrangement structure of the R, G, and B subpixels may include all the structures of binding the R, G, and B subpixels in one pixel and arranging it consecutively.

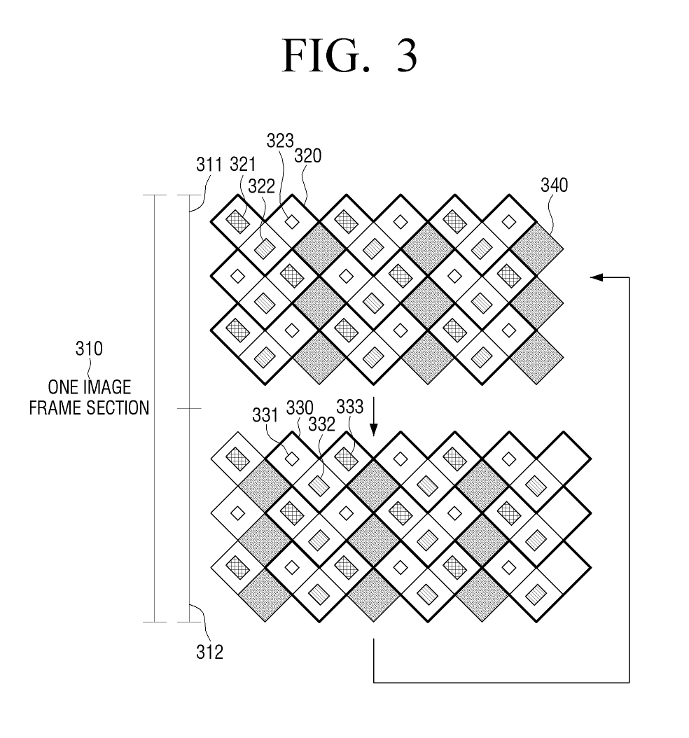

FIG. 3 illustrates a process of controlling a plurality of subpixels according to an exemplary embodiment.

The controller 130 may turn on a plurality of subpixels based on a predetermined group unit in a first subfield section of one image frame section, and subsequently turn on groups of subpixels which are in locations shifted to include a portion of the subpixels turned on in the first subfield section and which are based on the predetermined group unit, in a second subfield section of the same image frame section.

With reference to FIG. 3, in a first subfield section 311 of one image frame section 310, the controller 130 may turn on a plurality of R, G, and B subpixels by binding three subpixels into a predetermined group unit 320 having the V shape. More specifically, the predetermined group unit 320 having the V shape includes an R subpixel 323, a G subpixel 322, and a B subpixel 321, and is arranged consecutively to form a plurality of pixels.

Accordingly, among the plurality of R, G, and B subpixels, a subpixel 340, which is not included in the consecutively arranged group units having the V shape (i.e., the predetermined group units 320), is not turned on when the consecutively arranged group units are turned on, but is turned off. For example, as illustrated in FIG. 3, the subpixel 340 which is not included in the group units having the V shape is illustrated in black to indicate the turned-off state in the first subfield section 311.

In addition, in a second subfield section 312 of the image frame section 310, the controller 130 may turn on a group of subpixels 330 which has the same shape as the predetermined group units 320 and which is in a location shifted to include a portion of the subpixels 321, 322, and 323 turned on in the first subfield section 311.

That is, the R subpixel 323 among the subpixels 321, 322, and 323 turned on in the first subfield section 311 is the same as an R subpixel 331 in the group of subpixels 330 which is in the shifted location and is turned on in the second subfield section 312.

Accordingly, the R subpixel 323 and 331 is turned on in the first subfield section 311 and is also turned on in the second subfield section 312. In addition, the group of subpixels 330, which is in the location shifted to include the R subpixel 323 turned on in the first subfield section 311, is turned on. That is, an interval shifted to include the R subpixel 323 turned on in the first subfield section 311 corresponds to the predetermined subpixel unit.

Consequently, in the second subfield section 312, the controller 130 turns on consecutively arranged groups of the subpixels 330, including a plurality of subpixels which are located between the predetermined group units turned on in the first subfield section 311.

In addition, since the controller 130 turns on a plurality of subpixels by time sharing in one image frame section, more subpixels are turned on than in the case where a plurality of subpixels are tuned on once per image frame section (i.e., without time sharing). Accordingly, an effect of compensating for the resolution of the display panel is realized.

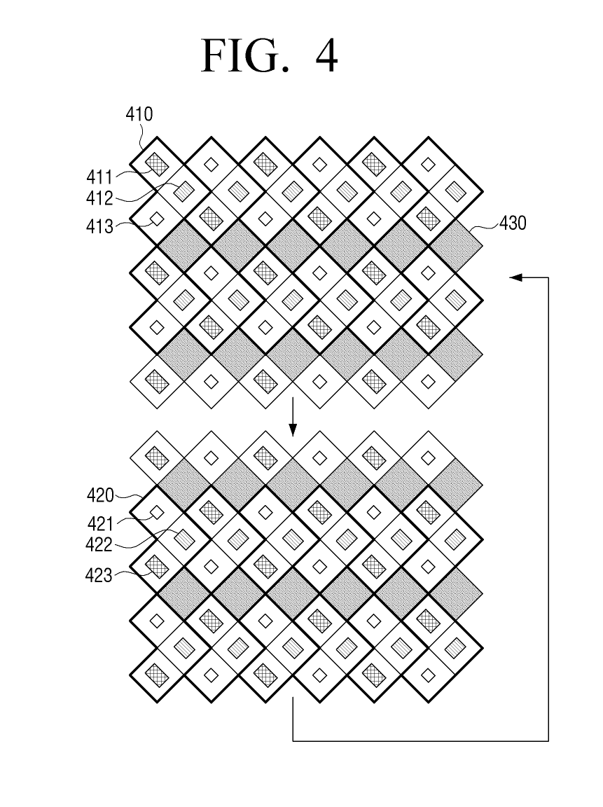

FIGS. 4 to 12 illustrate a process of controlling a plurality of subpixels according to other exemplary embodiments.

With reference to FIG. 4, in a first subfield section of one image frame section, the controller 130 may turn on a plurality of R, G, and B subpixels by binding three subpixels into a predetermined group unit 410 having a > shape (i.e., a V shape rotated 90 degrees counterclockwise). More specifically, the predetermined group unit 410 of the > shape includes an R subpixel 413, a G subpixel 412, and a B subpixel 411, and is arranged consecutively.

In addition, as in FIG. 3, among the plurality of R, G, and B subpixels, a subpixel 430, which is not included in the consecutively arranged group units 410 having the > shape, is not turned on when the consecutively arranged group units are turned on, but is turned off. For example, as illustrated in FIG. 4, the subpixel 340 which is not included in the group units having the > shape is illustrated in black to indicate the turned-off state in the first subfield section.

In addition, in a second subfield section of the image frame section, the controller 130 may turn on a group of subpixels 420 which has the same shape as the predetermined group units and which is in a location shifted to include a portion of the subpixels 411, 412, and 413 turned on in the first subfield section.

That is, the R subpixel 413 among the subpixels 411, 412, and 413 turned on in the first subfield section is the same as an R subpixel 421 in the group of subpixels 421, 422, and 423 which is in the shifted location and is turned on in the second subfield section.

Accordingly, the R subpixel 413 and 421 is turned on in the first subfield section and is also turned on in the second subfield section. In addition, the group of subpixels 420, which is in the location shifted to include the R subpixel 413 turned on in the first subfield section, is turned on. An interval shifted to include the R subpixel 413 turned on in the first subfield section corresponds to the predetermined subpixel unit.

Consequently, in the second subfield section, the controller 130 turns on consecutively arranged groups of the subpixels 420 including a plurality of subpixels which are located between the predetermined group units 410 turned on in the first subfield section.

The controller 130 may sequentially turn on groups of subpixels which are in locations shifted by the predetermined subpixel unit in at least one of the vertical and horizontal directions in the second subfield section.

For example, as shown in FIG. 3, the controller 130 may sequentially turn on groups of subpixels 330 which are in locations horizontally shifted (i.e., with respect to the groups of subpixels 320) by the predetermined subpixel unit in the second subfield section 312. The predetermined subpixel unit is an interval shifted to include the R subpixel 323 turned on in the first subfield section 311 as described above.

In addition, as shown in FIG. 4, the controller 130 may sequentially turn on groups of subpixels 420 which are in locations vertically shifted (i.e., with respect to the groups of subpixels 410) by the predetermined subpixel unit in the second subfield section. The predetermined subpixel unit is an interval shifted to include the R subpixel 413 turned on in the first subfield section as described above.

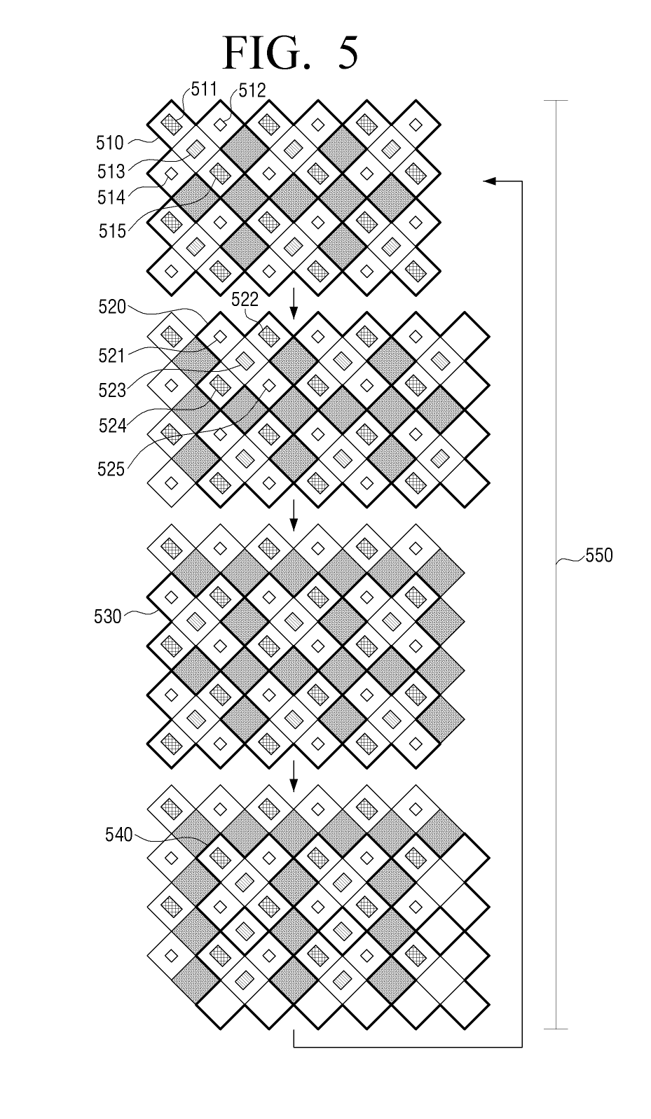

The group units 320 and 330 having the V shape in FIG. 3 and the group units 410 and 420 having the > shape in FIG. 4 are determined according to a luminous pattern of the subpixels. The luminous pattern of the subpixels may include diverse shapes as well as the shapes of group units shown in FIGS. 3 and 4. More luminous patterns are described below with reference to FIGS. 5-12. However, there luminous patterns are merely exemplary and not limited thereto.

With reference to FIG. 5, a predetermined group unit has an X shape. In particular, in FIG. 5, in the four subfield sections during one image frame section 550, the controller 130 may turn on a plurality of R, G, and B subpixels by binding the subpixels based on a predetermined group unit 510, 520, 530, or 540 having the X shape. Compared to turning on a plurality of R, G, and B subpixels by binding the subpixels based on a predetermined group unit in the two subfield sections during one image frame section (i.e., as illustrated in FIGS. 3 and 4), the controller 130 may turn on a plurality of R, G, and B subpixels by binding the subpixels based on a predetermined group unit using a faster driving frequency than in the exemplary embodiments illustrated in FIGS. 3 and 4.

For example, in a first subfield section of the image frame section 550, the controller 130 may turn on a plurality of R, G, and B subpixels by binding the subpixels based on a predetermined group unit 510 having the X shape. More specifically, the predetermined group unit 510 having the X shape includes a total of five subpixels including two R subpixels 512 and 514, a G subpixel 513, and two B subpixels 511 and 515, and is arranged consecutively.

In addition, in a second subfield section of the image frame section 550, the controller 130 may turn on a group of subpixels 520 which is in a location shifted to include a portion of the subpixels 511, 512, 513, 514, and 515 turned on in the first subfield section.

That is, the R subpixel 512 and the B subpixel 515 among the subpixels 511, 512, 513, 514, and 515 turned on in the first subfield section are the same as an R subpixel 521 and a B subpixel 524 among the subpixels 521, 522, 523, 524, and 525 in the group of subpixels 520 which is in the shifted location and is turned on in the second subfield section.

Accordingly, the R subpixel 512 or 522 and the B subpixel 515 or 524 are turned on in the first subfield section and are also turned on in the second subfield section. In addition, the group of subpixels 520, which is in the location shifted to include the R subpixel 512 and the B subpixel 515 turned on in the first subfield section, is turned on. An interval shifted to include the R subpixel 512 and the B subpixel 515 turned on in the first subfield section corresponds to the predetermined subpixel unit.

In the second subfield section, the controller 130 may sequentially turn on the group of subpixels 520 which is in the location horizontally shifted by the predetermined subpixel unit with respect to the predetermined group unit 510 turned on in the first subfield section. Subsequently, in a third subfield section, the controller 130 may sequentially turn on a group of subpixels 530 which is in a location vertically shifted by the predetermined subpixel unit with respect to the predetermined group unit 510 turned on in the first subfield section.

Subsequently, in a fourth subfield section, the controller 130 may sequentially turn on a group of subpixels 540 which is in a location vertically and horizontally shifted by the predetermined subpixel unit with respect to the predetermined group unit 510 turned on in the first subfield section.

The predetermined subpixel unit in the third and fourth subfield sections corresponds to an interval shifted to include a portion of the subpixels turned on in the first subfield section as described in the second subfield section.

In FIG. 5, the controller 130 turns on a different plurality of subpixels at four separate times during the image frame section 550, thereby further increasing the effect of compensating for the resolution of the display panel (e.g., as compared to the exemplary embodiments illustrated in FIGS. 3 and 4).

Consequently, in the second to fourth subfield sections, the controller 130 sequentially turns on groups of the subpixels 520, 530, and 540 including a plurality of subpixels which are located between the predetermined group units 510 turned on in the first subfield section.

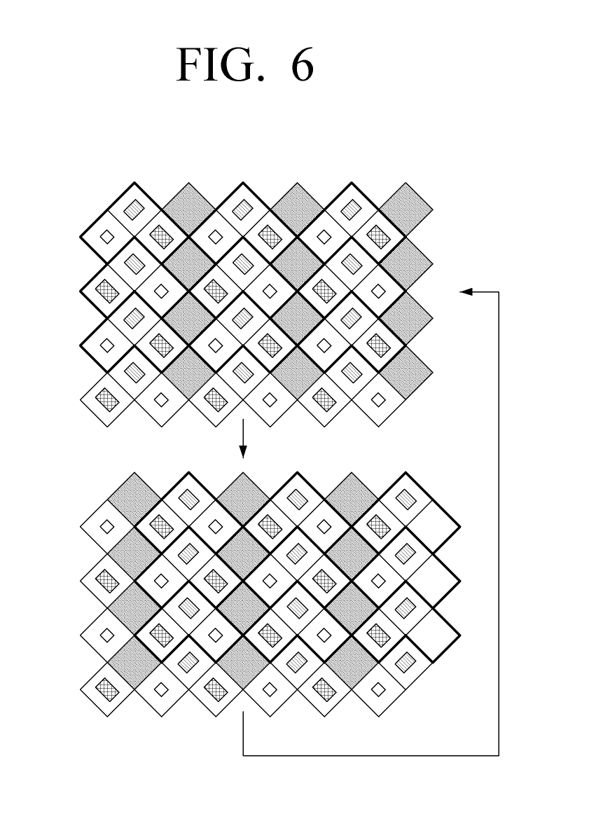

With reference to FIG. 6, a predetermined group unit has a ̂ shape (i.e., a V shape rotated 180 degrees).

In a first subfield section of an image frame section, the controller 130 may turn on a plurality of R, G, and B subpixels by binding the subpixels based on a predetermined group unit having the ̂ shape. Subsequently, in a second subfield section of the image frame section, the controller 130 may turn on a group of subpixels which is in a location shifted to include a portion of the subpixels turned on in the first subfield section. Compared to FIG. 4, only the shapes of the predetermined group unit are different, but the turn-on processes are the same. Accordingly, a detailed description is omitted.

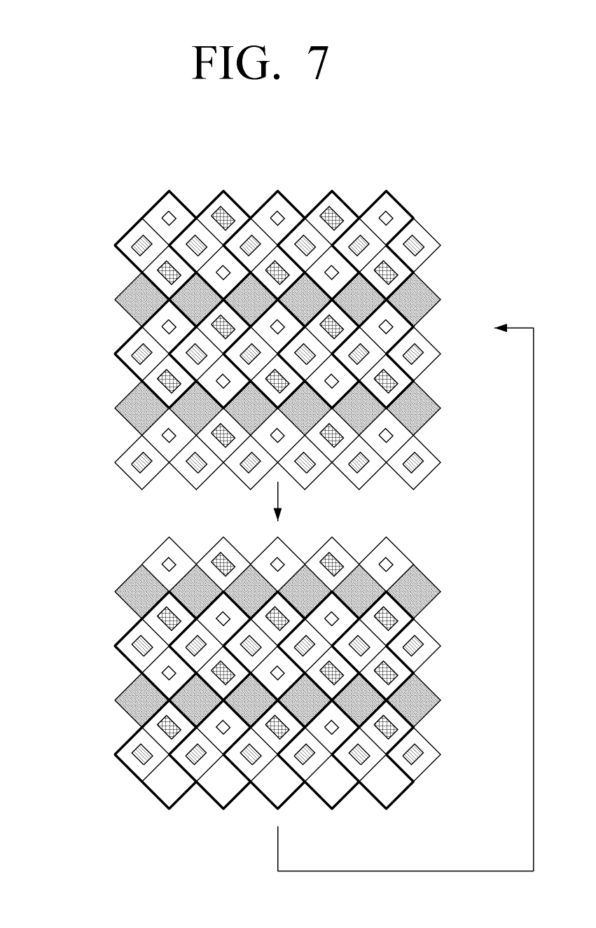

With reference to FIG. 7, a predetermined group unit has a < shape (i.e., a V shape rotated 90 degrees clockwise).

In a first subfield section of an image frame section, the controller 130 may turn on a plurality of R, G, and B subpixels by binding the subpixels based on a predetermined group unit having the ̂ shape. Subsequently, in a second subfield section of the image frame section, the controller 130 may turn on a group of subpixels which is in a location shifted to include a portion of the subpixels turned on in the first subfield section. Compared to FIG. 4, only the shapes of the predetermined group unit are different, but the turn-on processes are the same. Accordingly, a detailed description is omitted.

A plurality of subpixels may further include at least one of white (W) and yellow (Y) subpixels.

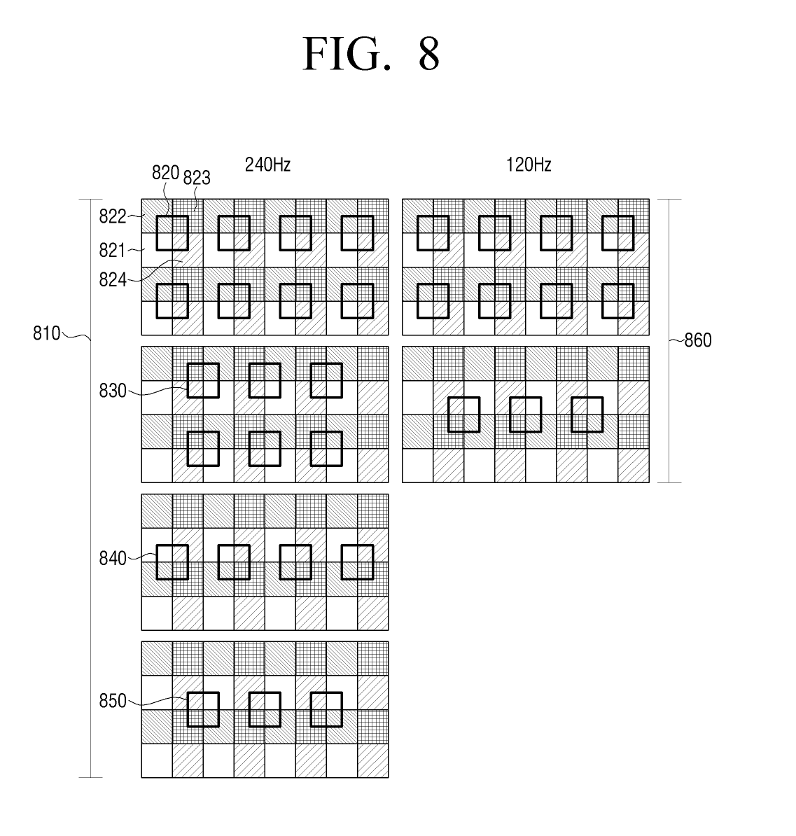

For example, FIG. 8 illustrates a display including a plurality of R, G, B, and W subpixels. Four subpixels, an R subpixel 821, a G subpixel 822, a B subpixel 823, and a W subpixel 824, compose a pixel. The W subpixels output white light, thereby increasing the brightness of the display panel.

In addition, the arrangement structure of the subpixels shown in FIG. 8 is not a structure in which subpixels are diagonally arranged side by side as shown in FIGS. 2 to 7, but instead is a PenTile structure in which subpixels of a square form are arranged side by side.

However, the operation of time-sharing and controlling the plurality of subpixels according to an exemplary embodiment is also applicable to the PenTile structure.

A process of controlling the plurality of subpixels using 240 Hz as a driving frequency of the display panel 110 is described below.

When a driving frequency of 240 Hz is used, the controller 130 may turn on, in each of the four subfield sections during one image frame section 810, a plurality of R, G, B, and W subpixels by binding the subpixels based on a predetermined group unit using the 240 Hz driving frequency, as in the exemplary embodiment illustrated in FIG. 5.

In a first subfield section of the image frame section 810, the controller 130 may turn on R, G, B, and W subpixels 821, 822, 823, and 824 by binding the subpixels based on a predetermined group unit 820. The predetermined group unit 820 is arranged consecutively.

In addition, in a second subfield section of the image frame section 810, the controller 130 may turn on a group of subpixels 830 which is in a location shifted to include a portion of the subpixels 821, 822, 823, and 824 turned on in the first subfield section.

That is, the B subpixel 823 and the W subpixel 824 turned on in the first subfield section are also turned on in the second subfield section. Accordingly, the group of subpixels 830, which is in the location shifted to include the B subpixel 823 and the W subpixel 824 turned on in the first subfield section, is turned on. An interval shifted to include the B subpixel 823 and the W subpixel 824 turned on in the first subfield section corresponds to the predetermined subpixel unit.

In addition, as in the exemplary embodiment illustrated in FIG. 5, in the second subfield section, the controller 130 may sequentially turn on the group of subpixels 830 which is in the location horizontally shifted by the predetermined subpixel unit with respect to the predetermined group unit 820 turned on in the first subfield section. Subsequently, in a third subfield section, the controller 130 may sequentially turn on a group of subpixels 840 which is in a location vertically shifted by the predetermined subpixel unit with respect to the predetermined group unit 820 turned on in the first subfield section.

Subsequently, in a fourth subfield section, the controller 130 may sequentially turn on a group of subpixels 850 which is in a location vertically and horizontally shifted by the predetermined subpixel unit with respect to the predetermined group unit 820 turned on in the first subfield section.

The predetermined subpixel unit in the third and fourth subfield sections corresponds to an interval shifted to include a portion of the subpixels turned on in the first subfield section as described in the second subfield section.

In addition, as in exemplary embodiment illustrated in FIG. 5, the controller 130 turns on a plurality of subpixels four times during the image frame section 810, thereby further increasing the effect of compensating for the resolution (e.g., as compared to the exemplary embodiments illustrated in FIGS. 3 and 4).

Consequently, in the second to fourth subfield sections, the controller 130 sequentially turns on groups of the subpixels 830, 840, and 850 including a plurality of subpixels which are located between the predetermined group units 820 turned on in the first subfield section.

When the plurality of subpixels are controlled using a driving frequency of 120 Hz, the controller 130 may sequentially turn on a plurality of R, G, B, and W subpixels by binding the subpixels based on a predetermined group unit in the two subfield sections during one image frame section 860.

For example, in a first subfield section of the image frame section 860, the controller 130 may turn on R, G, B, and W subpixels by binding the subpixels based on a predetermined group unit. Subsequently, in a second subfield section of the image frame 860, the controller 130 may turn on a group of subpixels which is in a location shifted to include a portion of the subpixels turned on in the first subfield section.

The controller 130 may shift groups of subpixels by applying the predetermined subpixel unit differently according to the driving frequency of the display panel 110.

That is, when the driving frequency of 240 Hz is used, the controller 130 may sequentially turn on the plurality of subpixels by binding the subpixels based on a predetermined group unit and shifting in a total of four subfield sections, whereas when the driving frequency of 120 Hz is used, the controller 130 may sequentially turn on the plurality of subpixels by binding the subpixels based on a predetermined group unit and shifting in a total of two subfield sections. Accordingly, the predetermined subpixel units, which correspond to a shift interval, are different.

For example, when the driving frequency of 120 Hz is used, the controller 130 may turn on a group of subpixels which is in a location vertically and horizontally shifted by a predetermined subpixel unit in the second subfield section. Compared to turning on a group of subpixels which is in a location horizontally shifted by the predetermined subpixel unit in the second subfield section using the driving frequency of 240 Hz is used, the shifted amount is different.

That is, when the driving frequency of 120 Hz is used, the controller 130 omits the process of turning on a plurality of subpixels in the second and third subfield sections of the case of using the driving frequency of 240 Hz, and only performs the process of turning on a plurality of subpixels in the first and fourth subfield sections. Accordingly, the user may feel the effect of compensating for the resolution of the display panel.

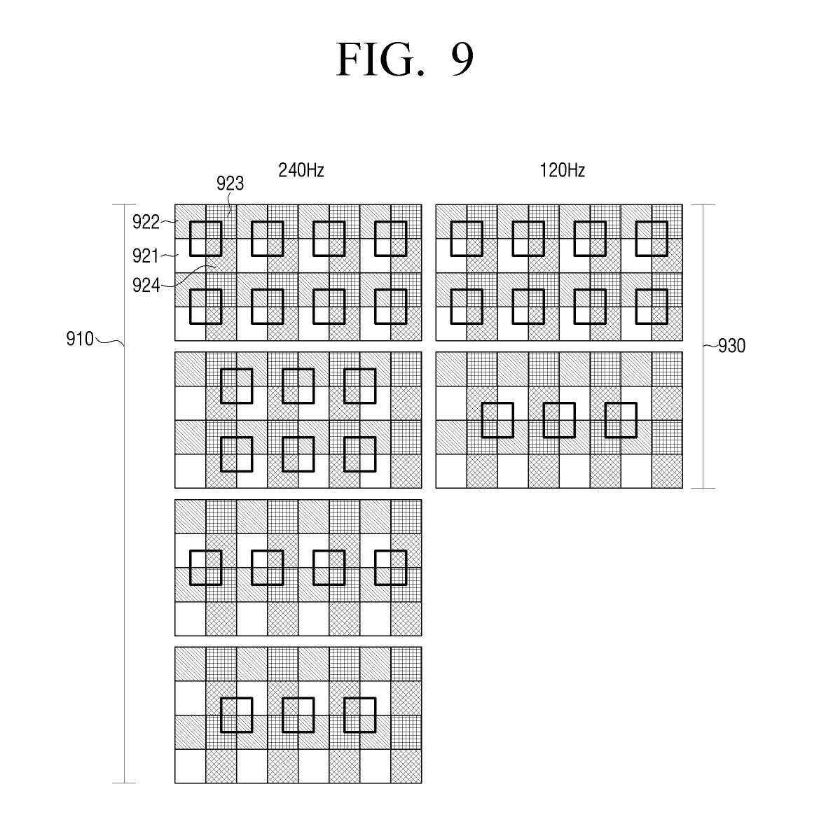

FIG. 9 illustrates a display including a plurality of R, G, B, and yellow (Y) subpixels. Four subpixels, an R subpixel 921, a G subpixel 922, a B subpixel 923, and a Y subpixel 924, compose a pixel. The Y subpixels output yellow light, thereby increasing the contrast due to emphasized color contrast.

In FIG. 9, when the driving frequency of 240 Hz is used, the controller 130 may sequentially turn on the plurality of subpixels by binding the subpixels based on a predetermined group unit and shifting in a total of four subfield sections during one image frame section 910, whereas when the driving frequency of 120 Hz is used, the controller 130 may sequentially turn on the plurality of subpixels by binding the subpixels based on a predetermined group unit and shifting in a total of two subfield sections during one image frame section 930, as in the exemplary embodiment illustrated in FIG. 8. Accordingly, the predetermined subpixel units, which correspond to a shift interval, are different.

In FIG. 9, the W subpixels in FIG. 8 are replaced with Y subpixels, and the process of controlling the plurality of subpixels is the same as that of FIG. 8. Accordingly, detailed description of the process is not repeated.

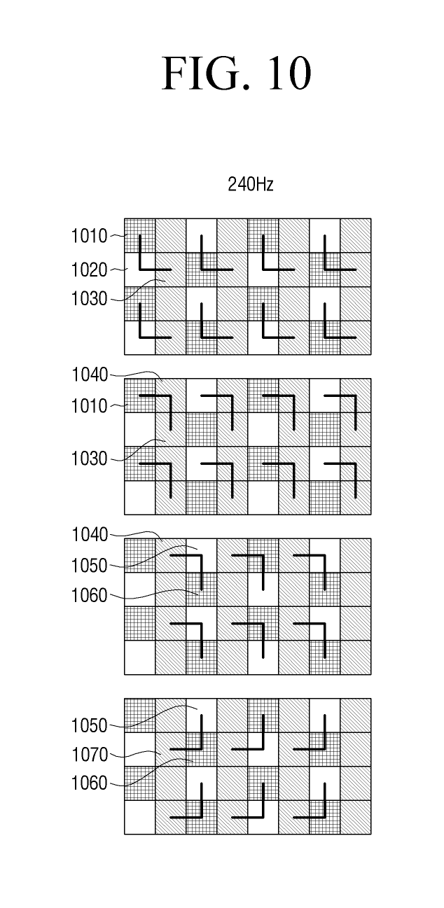

FIG. 10 illustrates a display including a plurality of R, G, and B subpixels. Four subpixels, an R subpixel 1020, a G subpixel 1030, a B subpixel 1010, and a G subpixel 1040 compose a pixel. That is, an R subpixel, a B subpixel, and two G subpixels compose a pixel.

In FIG. 10, when the driving frequency of 240 Hz is used, the controller 130 sequentially turns on the plurality of R, G, and B subpixels by binding the subpixels based on a predetermined group unit in the four subfield sections during one image frame, section as in exemplary embodiments illustrated in FIGS. 8 and 9.

In a first subfield section of the image frame section, the controller 130 may turn on a plurality of R, G, and B subpixels 1020, 1030, and 1010 by binding the subpixels based on a predetermined group unit. The └ sign shown on each group unit in FIG. 10 indicates the predetermined group unit of the turned-on subpixels. The predetermined group unit is arranged consecutively.

In one image frame section, the controller 130 may control the panel driver 120 to turn on a plurality of subpixels based on a predetermined group unit and subsequently turn on a group of subpixels which is in a location rotated at a predetermined angle.

With reference to FIG. 10, in a second subfield section of the image frame section, the controller 130 may turn on a group of subpixels which is in a location rotated at a predetermined angle to include a portion of the subpixels 1010, 1020, and 1030 turned on in the first subfield section.

More specifically, the controller 130 turns on a B subpixel 1010, a G subpixel 1040, and a G subpixel 1030 which are in the location rotated at the predetermined angle.

That is, the B subpixel 1010 and the G subpixel 1030 turned on in the first subfield section are also turned on in the second subfield section. Accordingly, the group of subpixels, which is in the location rotated at the predetermined angle to include the B subpixel 1010 and the G subpixel 1030 turned on in the first subfield section, is turned on. An interval rotated to include the B subpixel 1010 and the G subpixel 1030 turned on in the first subfield section corresponds to the predetermined angle.

Subsequently, in a third subfield section, the controller 130 may sequentially turn on a group of subpixels which is in a location horizontally shifted by a predetermined subpixel unit with respect to the predetermined group unit turned on in the second subfield section.

That is, a group of subpixels, which is in a location shifted to include the G subpixel 1040 and the R subpixel 1050 turned on the second subfield section, are turned on. More specifically, the controller 130 turns on the G subpixel 1040, the R subpixel 1050, and a B subpixel 1060 which are in the shifted location.

Subsequently, in a fourth subfield section, the controller 130 may turn on a group of subpixels which is in a location rotated at a predetermined angle to include a portion of the subpixels 1040, 1050, and 1060 turned on in the third subfield section.

More specifically, the controller 130 turns on an R subpixel 1050, a B subpixel 1060, and a G subpixel 1070 which are in the location rotated at the predetermined angle.

That is, the R subpixel 1050 and the B subpixel 1060 turned on in the third subfield section are also turned on in the fourth subfield section. Accordingly, the group of subpixels, which is in the location rotated at the predetermined angle to include the R subpixel 1050 and the B subpixel 1060 turned on in the third subfield section, is turned on. An interval rotated to include the R subpixel 1050 and the B subpixel 1060 turned on in the third subfield section corresponds to the predetermined angle.

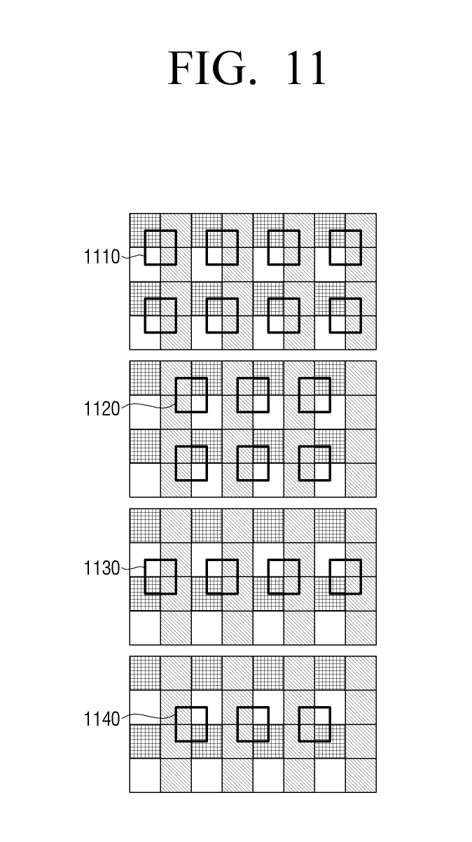

In FIG. 11, the W subpixels in FIG. 8 or the Y subpixels in FIG. 9 are replaced with G subpixels, and except for this difference, the process of controlling the plurality of subpixels is the same as that of FIGS. 8 and 9.

That is, in a first subfield section of one image frame section, the controller 130 may turn on an R subpixel, a B subpixel, and two G subpixels by binding the subpixels based on a predetermined group unit 1110.

Subsequently, in a second subfield section of the image frame section, the controller 130 may turn on a group of subpixels 1120 which is in a location shifted to include a portion of the subpixels turned on in the first subfield section.

Similarly, in third and fourth subfield sections of the image frame section, the controller 130 may sequentially turn on groups of subpixels 1130 and 1140, respectively, which are in locations shifted to include a portion of the subpixels turned on in the first subfield section.

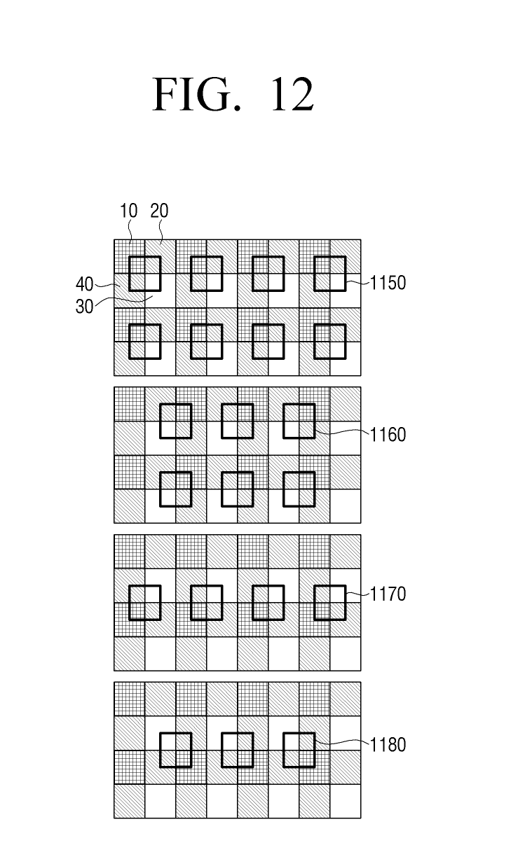

In FIG. 12, the location of the G subpixels in the structure of the subpixels shown in FIG. 11 is changed. More specifically, a B subpixel 10, a G subpixel 20, an R subpixel 30, and a G subpixel 40 compose a pixel. In other words, an R subpixel, a B subpixel, and two G subpixels compose a pixel.

In a first subfield section of one image frame section, the controller 130 may turn on an R subpixel, a B subpixel, and two G subpixels by binding the subpixels based on a predetermined group unit 1150.

Subsequently, in a second subfield section of the image frame section, the controller 130 may turn on a group of subpixels 1160 which is in a location shifted to include a portion of the subpixels turned on in the first subfield section.

Similarly, in third and fourth subfield sections of the image frame section, the controller 130 may sequentially turn on groups of subpixels 1170 and 1180, respectively, which are in locations shifted to include a portion of the subpixels turned on in the first subfield section.

Since the process of controlling the plurality of subpixels has been described above with reference to FIGS. 8 and 9, a detailed description is not repeated.

According to an exemplary embodiment, the subpixels of the display panel 110 may be implemented with light emitting diodes (LEDs). Accordingly, when the subpixels that compose the display panel 110 are implemented with LEDs, a backlight is not required as in the case of liquid crystal display (LCD) panels.

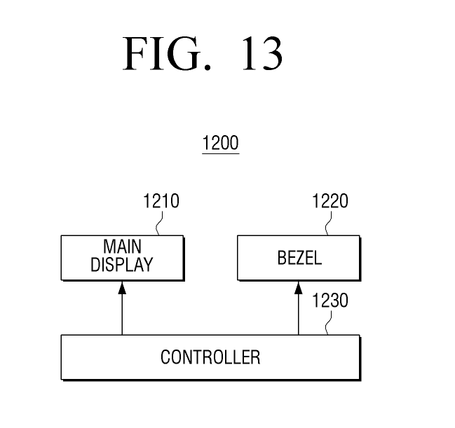

FIG. 13 is a block diagram of a configuration of a display apparatus according to another exemplary embodiment.

With reference to FIG. 13, the display apparatus 1200 may include a main display 1210, a bezel 1220, and a controller 1230.

The main display 1210 displays an image corresponding to an image signal which is input.

The bezel 1220 includes a sub-display which consists of a plurality of subpixels including R, G, and B subpixels. More specifically, the sub-display, which consists of the plurality of subpixels, including R, G, and B subpixels, is attached to the bezel 1220.

Accordingly, an image may be displayed on the main display 1210 and the sub-display attached to the bezel 1220. A display area of the main display 1210 and a display area of the sub-display may display a connected image such that the display 1200 appears to be a display which does not have a bezel (i.e., a bezel-less display apparatus).

The controller 1230 scales an input image signal to correspond to the display area of the main display 1210 and the display area of the sub-display, divides the scaled image signal into portions corresponding to the respective display areas, and outputs the image signal.

For example, an image signal having a resolution of full high-definition (HD) 1920*1080 may be input. When the sum of a resolution of the display area of the main display 1210 and a resolution of the display area of the sub-display is higher than the resolution of the input image signal, the controller 1230 may up-scale the input image signal. The up-scaled image signal is then divided into portions corresponding to the display area of the main display 1210 and the display area of the sub-display, and output.

In a portion of an image frame section displayed on the display area of the sub-display, the controller 1230 may turn on a plurality of subpixels based on a predetermined group unit, and sequentially turn on a group of subpixel which is in a location shifted by a predetermined subpixel unit.

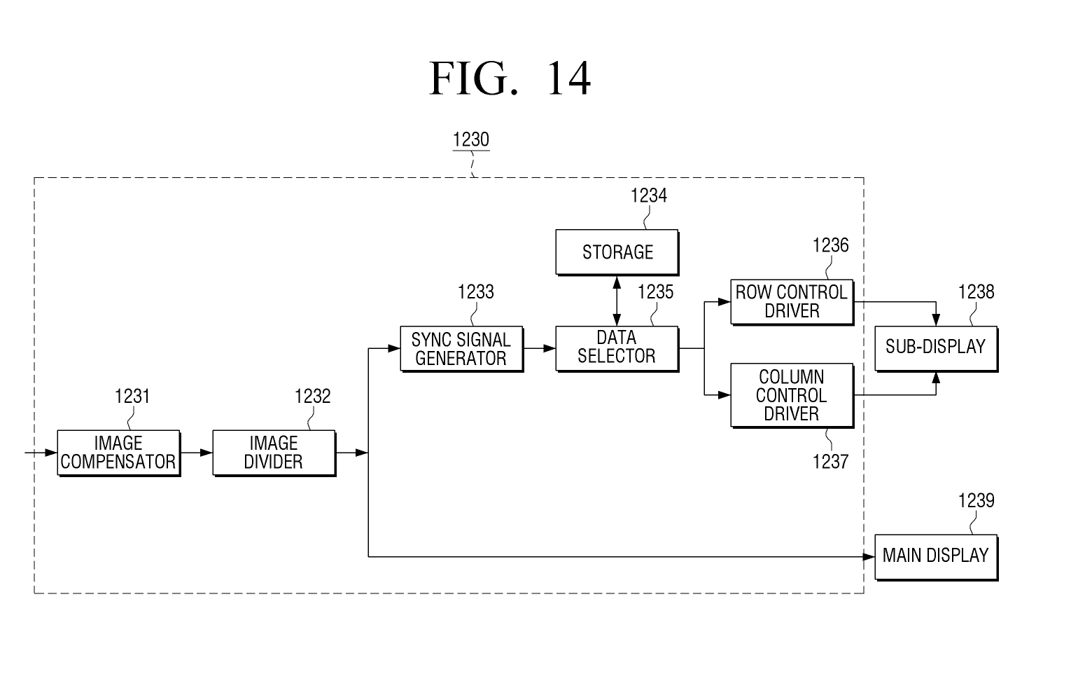

FIG. 14 is a block diagram of a detailed configuration of the controller 1230 according to an exemplary embodiment.

With reference to FIG. 14, the controller 1230 may include an image compensator 1231, an image divider 1232, a sync signal generator 1233, a storage 1234, a data selector 1235, a row control driver 1236, and a column control driver 1237.

The image compensator 1231 may up-scale an input image signal according to the resolution determined based on a display area of a main display 1239 and a display area of a sub-display 1238.

For example, when a resolution of an input image signal is 1920*1080 and a resolution determined based on the display area of the main display 1239 and the display area of the sub-display 1238 is 1932*1086, the image compensator 1231 up-scales the image signal by e.g., 12*1080+6*1932, which is the difference between the resolution of the image signal and the determined resolution.

In addition, the image divider 1232 may divide the up-scaled image signal into portions corresponding to the display areas.

For instance, in the above example, the image divider 1232 may divide the up-scaled image signal into an image signal corresponding to the display area of the main display 1239 and an image signal corresponding to the display area of the sub-display 1238 respectively.

For example, when the display area of the sub-display 1238 is divided into four areas (e.g., corresponding to each portion of the bezel), the image divider 1232 may divide the up-scaled image signal of corresponding to the sub-display 1238 into four image signals having a resolution corresponding to each portion of the bezel. For instance, the image divider 1232 may divide the up-scaled image signal corresponding to the sub-display 1238 into two image signals having a resolution of 6*1080 each and two image signals having a resolution of 3*1932 each.

The sync signal generator 1233 may generate a sync signal to drive the sub display 1238.

The storage 1234 may the image signal allocated to the display area of the sub-display 1238. In the above example, when the sub-display 1238 is divided into the four areas, the storage 1234 may store the four image signals having the above resolutions (i.e., 6*1080 or 3*1932) allocated to each area.

The data selector 1235 may transmit an image stored in the storage 1234 to the sub-display 1238 based on a sync signal so that the sub-display 1238 may display the received image.

The controller 1230 may include the row control driver 1236, and the column control driver 1237. The row control driver 1236 and the column control driver 1237 may sequentially turn on groups of subpixels which are in locations horizontally and/or vertically shifted by a predetermined subpixel unit.

Using the components of the controller 1230, the controller 1230 may turn on a plurality of subpixels based on a predetermined group unit in a first subfield section of one image frame section, and subsequently turn on groups of subpixels which are in locations shifted to include a portion of the subpixels turned on in the first subfield section, in a second subfield section of the same image frame section.

The plurality of subpixels included in the sub-display of the display apparatus 1200 may be implemented with LEDs.

The main display 1239 and the sub-display 1238 which is composed of LEDs attached to the bezel 1220 are physically divided but operate as one display, thereby displaying one image.

Accordingly, the user may feel like he or she is watching an image using a bezel-less display.

Since a method for controlling a plurality of subpixels with respect to the sub-display including the plurality of subpixels has been described above, detailed description is not repeated.

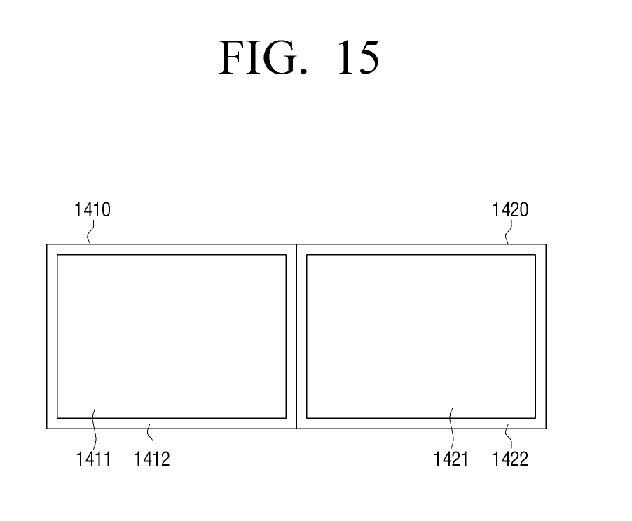

FIG. 15 illustrates a display system including a plurality of display apparatuses according to an exemplary embodiment.

With reference to FIG. 15, the display system may include a plurality of display apparatuses 1410 and 1420 including main displays 1411 and 1421, and bezels 1412 and 1422 to which sub-displays composed of a plurality of subpixels including R, G, and B subpixels are attached, respectively.

Each display apparatus 1410 and 1420 may scale an input image signal to correspond to the display area of the main display 1411 and 1421 and the display area of the sub-display, divide the scaled image signal into portions corresponding to the display areas, output the image signal, and in one image frame section displayed on the display area of the sub-display, sequentially turn on a plurality of subpixels based on a predetermined group unit, and turn on groups of subpixels which is in a location shifted by a predetermined subpixel unit.

That is, each of the display apparatuses 1410 and 1420 may display a portion of an image corresponding to an image signal such that a video wall system capable of displaying one image using the display apparatuses 1410 and 1420 may be realized.

FIG. 15 illustrates the bezels 1412 and 1422 and the main displays 1411 and 1421 of the display apparatuses 1410 and 1420 separately.

However, if the sub-displays including a plurality of subpixels including R, G, and B subpixels, according to an exemplary embodiment, are attached to the bezels 1412 and 1422, the main displays 1411 and 1421 and the sub-display appear as a single bezel-less display.

Since a method for controlling a plurality of subpixels with respect to the sub-display including the plurality of subpixels has been described above, detailed description is not repeated.

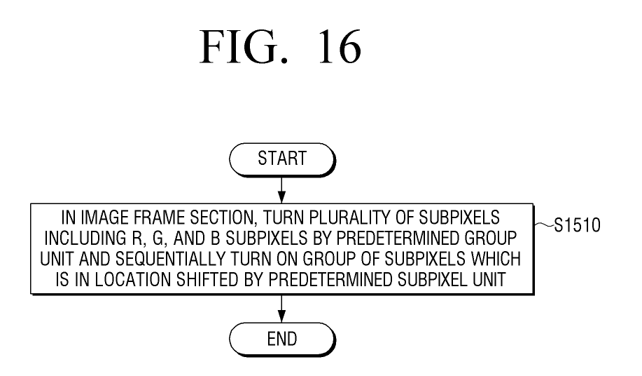

FIG. 16 is a flow chart of a control method of a display apparatus including a display panel composed of a plurality of subpixels including red (R), green (G), and blue (B) subpixels according to an exemplary embodiment.

With reference to FIG. 16, in one image frame section, the display apparatus may sequentially turn on a plurality of subpixels based on a predetermined group unit, and turn on a group of subpixels which is in a location shifted by a predetermined subpixel unit.

In the turning-on operation, the display apparatus may sequentially turn on the plurality of subpixels based on the predetermined group unit in a first subfield section of the image frame section, and turn on the group of subpixels which is in the location shifted to include a portion of the subpixels turned on in the first subfield section in a second subfield section of the same image frame section (S1510).

In the turning-on operation, the display apparatus may sequentially turn on the group of subpixels which is in the location shifted by the predetermined subpixel unit in at least one of a vertical direction and a horizontal direction in the second subfield section.

The predetermined group unit may be determined according to a luminous pattern of the subpixels.

In the turning-on operation, in the image frame section, the display apparatus may also sequentially turn on the plurality of subpixels based on the predetermined group unit, and turn on a group of subpixels which is in a location rotated at a predetermined angle.

In addition, the plurality of subpixels may further include at least one of white (W) and yellow (Y).

The plurality of subpixels may be implemented with light emitting diodes (LEDs).

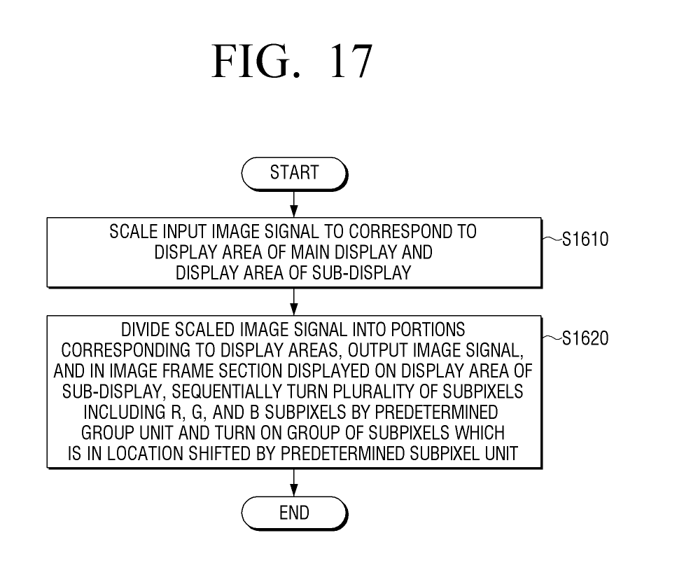

FIG. 17 is a flow chart of a control method of a display apparatus including a main display and a bezel to which a sub display composed of a plurality of subpixels including R, G, and B subpixels is attached according to another exemplary embodiment.

With reference to FIG. 17, the display apparatus may scale an input image signal to correspond to a display area of the main display and a display area of the sub-display (S1610).

Subsequently, the display apparatus may divide the scaled image signal into portions corresponding to the display areas, and output the image signal (S1620).

In the outputting operation, in one image frame section displayed on the display area of the sub-display, the display apparatus may sequentially turn on a plurality of subpixels based on a predetermined group unit, and turn on a group of subpixels which is in a location shifted by a predetermined subpixel unit.

The plurality of subpixels may be implemented with LEDs.

A non-transitory computer readable medium which stores a program to perform the methods described above may be provided.

For example, a non-transitory computer readable medium which stores a program to perform the operation of in one image frame section, sequentially turning on a plurality of subpixels based on a predetermined group unit, and turning on a group of subpixels which is in a location shifted by a predetermined subpixel unit may be provided.

Furthermore, a non-transitory computer readable medium which stores a program to perform the operation of scaling an input image signal to correspond to a display area of the main display and a display area of the sub-display, dividing the scaled image signal into portions corresponding to the display areas, and outputting the image signal may be provided.

The non-transitory computer readable medium may be a medium which stores data semi-permanently and is readable by devices. More specifically, the aforementioned applications or programs may be stored and provided in the non-transitory computer readable media such as compact disks (CDs), digital video disks (DVDs), hard disks, Blu-ray disks, universal serial buses (USBs), memory cards, and read-only memory (ROM).

In the block diagrams in which the display apparatus is illustrated, a bus is not illustrated, but communication among the components of the display apparatus may be performed by a bus. In addition, each device may further include at least one processor capable of performing the aforementioned operations, such as a central processing unit (CPU) and a microprocessor.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a display panel comprising a plurality of subpixels, the plurality of subpixels comprising red (R) subpixels, green (G) subpixels, and blue (B) subpixels;
a panel driver configured to drive the display panel; and
a controller configured to control the panel driver to, in one image frame section, sequentially turn on a first group of subpixels of the plurality of subpixels based on a predetermined group unit, and turn on a second group of subpixels of the plurality of subpixels, which is in a location shifted by a predetermined subpixel unit with respect to a location of the first group of subpixels.

2. The display apparatus as claimed in claim 1, wherein the controller is further configured to sequentially turn on the first group of subpixels in a first subfield section of the image frame section, and turn on the second group of subpixels in a second subfield section of the image frame section, and
wherein the second group of subpixels includes at least one subpixel included in the first group of subpixels.

3. The display apparatus as claimed in claim 2, wherein the location of the second group of subpixels is a location shifted by the predetermined subpixel unit in at least one of a vertical direction and a horizontal direction with respect to the location of the first group of subpixels.

4. The display apparatus as claimed in claim 2, wherein the predetermined group unit is determined according to a luminous pattern of the plurality of subpixels.

5. The display apparatus as claimed in claim 1, wherein the controller is further configured to shift the second group of subpixels by applying the predetermined subpixel unit differently according to a driving frequency of the display panel.

6. The display apparatus as claimed in claim 1, wherein the location of the second group of subpixels is a location rotated at a predetermined angle with respect to the location the first group of subpixels.

7. The display apparatus as claimed in claim 1, wherein the plurality of subpixels further comprises at least one of white (W) subpixels and yellow (Y) subpixels.

8. The display apparatus as claimed in claim 1, wherein each of the plurality of subpixels is implemented with a light emitting diode (LED).

9. A display apparatus comprising:
a main display;
a bezel to which a sub-display comprising a plurality of subpixels, the plurality of subpixels comprising red (R) subpixels, green (G) subpixels, and blue (B) subpixels, is attached; and
a controller configured to scale an input image signal to correspond to a display area of the main display and a display area of the sub-display, divide the scaled image signal into portions corresponding to the respective display areas, and output the divided image signal,
wherein the controller is further configured to, in one image frame section displayed on the display area of the sub-display, sequentially turn on a first group of subpixels of the plurality of subpixels based on a predetermined group unit, and turn on a second group of subpixels of the plurality of subpixels, which is in a location shifted by a predetermined subpixel unit with respect to a location of the first group of subpixels.

10. The display apparatus as claimed in claim 9, wherein the controller comprises:
an image compensator configured to up-scale the input image signal according to a resolution determined based on a resolution of the display area of the main display and a resolution of the display area of the sub-display;
an image divider configured to divide the up-scaled image signal into portions corresponding to the respective display areas;
a sync signal generator configured to generate a sync signal to drive the sub-display;
a storage configured to store the portion of the divided image signal corresponding to the display area of the sub-display; and
a data selector configured to transmit the portion of the divided image signal stored in the storage to the sub-display based on the sync signal.

11. The display apparatus as claimed in claim 9, wherein the controller is further configured to sequentially turn on the first group of subpixels in a first subfield section of the image frame section, and turn on the second group of subpixels in a second subfield section of the image frame section, and
wherein the second group of subpixels includes at least one subpixel included the first group of subpixels.

12. The display apparatus as claimed in claim 9, wherein each of the plurality of subpixels is implemented with a light emitting diode (LED).

13. A display system comprising:
a plurality of display apparatuses each comprising a main display, and a bezel to which a sub-display comprising a plurality of subpixels, the plurality of subpixels comprising red (R) subpixels, green (G) subpixels, and blue (B) subpixels, is attached,
wherein each display apparatus is configured to scale an input image signal to correspond to a display area of the main displays and a display area of the sub-displays, divide the scaled image signal into portions corresponding to the respective display areas of each display apparatus, output the divided image signal, and in one image frame section displayed on the respective display area of the sub-displays of each display apparatus, sequentially turn on a first group of subpixels of the plurality of subpixels based on a predetermined group unit, and turn on a second group of subpixels of the plurality of subpixels, which is in a location shifted by a predetermined subpixel unit with respect to a location of the first group of subpixels.

14. A method for controlling a display apparatus including a display panel composed of a plurality of subpixels, the plurality of subpixels including red (R) subpixels, green (G) subpixels, and blue (B) subpixels, the method comprising:
in one image frame section, sequentially turning on a first group of subpixels of the plurality of subpixels based on a predetermined group unit, and turning on a second group of subpixels of the plurality of subpixels, which is in a location shifted by a predetermined subpixel unit with respect to a location of the first group of subpixels.

15. The method as claimed in claim 14, wherein the first group of subpixels are turned on in a first subfield section of the image frame section, and the second group of subpixels are turned on in a second subfield section of the image frame section, and
wherein the second group of subpixels includes at least one subpixel included the first group of subpixels.

16. The method as claimed in claim 15, wherein the location of the second group of subpixels is a location shifted by the predetermined subpixel unit in at least one of a vertical direction and a horizontal direction with respect to the location of the first group of subpixels.

17. The method as claimed in claim 15, wherein the predetermined group unit is determined according to a luminous pattern of the plurality of subpixels.

18. The method as claimed in claim 14, wherein the location of the second group of subpixels is a location rotated at a predetermined angle with respect to the location of the first group of subpixels.

19. The method as claimed in claim 14, wherein the plurality of subpixels further includes at least one of white (W) subpixels and yellow (Y) subpixels.

20. A method of controlling a display apparatus including a main display, and a bezel to which a sub-display, including a plurality of subpixels, the plurality of subpixels including red (R) subpixels, green (G) subpixels, and blue (B) subpixels, is attached, the method comprising:
scaling an input image signal to correspond to a display area of the main display and a display area of the sub-display;
dividing the scaled image signal into portions corresponding to the respective display areas; and
outputting the divided image signal,
wherein the outputting the divided image signal comprises, in one image frame section displayed on the display area of the sub-display, sequentially turning on a first group of subpixels of the plurality of subpixels based on a predetermined group unit, and turning on a second group of subpixels of the plurality of subpixels, which is in a location shifted by a predetermined subpixel unit with respect to a location of the first group of subpixels.
